(19) United States
(12) Patent Application Publication
(10) Pub. No.: US 2008/0141324 A1
(43) Pub. Date: Jun. 12, 2008

(54) IPTV SUPPLEMENTARY SERVICE CONTROL SYSTEM AND METHOD

(75) Inventors: Chang Sup Keum, Daejeon-city (KR); Kisoon Sung, Daejeon-ctiy (KR); Ki Sook Chung, Daejeon-city (KR); Yoo Mi Park, Daejeon-ctiy (KR); Young Il Choi, Daejeon-city (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon-City (KR)

(21) Appl. No.: 11/930,568

(22) Filed: Oct. 31, 2007

(30) Foreign Application Priority Data
Dec. 8, 2006 (KR) 10-2006-0125089

(51) Int. Cl. H04N 7/173

(52) U.S. Cl. 725/116

(57) ABSTRACT

An IPTV supplementary service control system and an IPTV supplementary service method using the system are provided. The IPTV supplementary service control system decrypts an IPTV supplementary service request contained in an SOAP message contained in a set-top box in order to provide the IPTV supplementary service. The IPTV supplementary service control system generates a control command required to perform the requested IPTV supplementary service and transmits the control command to a head end which transmits a content via a multicast network. Accordingly, it is possible to easily generate and provide the IPTV supplementary service by remotely controlling the head end.

### BACKGROUND OF THE INVENTION

This application claims the priority of Korean Patent Application No. 2006-0125089, filed on Dec. 8, 2006, in the Korean Intellectual Property Office, the disclosure of which is incorporated herein in its entirety by reference.

1. Field of the Invention

The present invention relates to a method of providing an Internet protocol television (IPTV) supplementary service as a convergence service for communication and broadcasting, and more particularly, to an IPTV supplementary service control system and method of providing an IPTV supplementary service by remotely controlling a head end.

This work was supported by the IT R&D program of MIC/IITA[2005-S-056-02, Development of Open API and Service Platform Technologies].

2. Description of the Related Art

In a conventional IPTV service, set-top boxes are directly connected to TVs via a high speed Internet device, so that users can performs tasks on the Internet while viewing a movie, a drama, sports, or the like.

However, the conventional IPTV service is a simple combination of a TV viewing service and an Internet service. Therefore, it is difficult to provide a convergence of communication and broadcasting such as a “community TV” supplementary service. In the community TV supplementary service, a number of remotely located users watching TVs seem to be located at one site Conventionally, in order to implement the community TV supplementary service, separate servers are needed. In addition, in order to provide a newly-developed supplementary service (for example, a family searching service of searching for family members and positioning their sites on a map), an additional server is also needed. Since additional servers are needed to provide newly-developed services and a method of generating the supplementary service differs according to the type of the supplementary service, high cost and long time are required for developing and implementing the new supplementary service. Therefore, IPTV supplementary services other than the simple viewing service are not actively provided and used.

### SUMMARY OF THE INVENTION

The present invention provides an IPTV supplementary service system and method capable of easily providing an IPTV supplementary service by remotely controlling a head end.

The present invention also provides a method of providing an IPTV supplementary service of inviting a person using an IPTV supplementary service system for remotely controlling a head end.

The present invention also provides method of providing an IPTV supplementary service of monitoring a channel of another person using an IPTV supplementary service system for remotely controlling a head end.

According to an aspect of the present invention, there is provided an IPTV supplementary service control system including a SOAP message processing unit which decrypts an IPTV supplementary service request contained in a SOAP message received from a set-top box; and a head end remote controller which generates a control command required to perform the requested IPTV supplementary service and transmits the control command to an head end which transmits a content to the set-top box via a multicast network.

According to another aspect of the present invention, there is provided a method of providing an IPTV supplementary service by remotely controlling a head end in an IPTV supplementary service control system, the method including the operations of decrypting an IPTV supplementary service request contained in an SOAP message received from a set-top box; and generating a control command required to perform the request IPTV supplementary service and transmitting the control command to a head end which transmits a content to the set-top box via a multicast network.

According to another aspect of the present invention, there is provided a method of providing an IPTV supplementary service for monitoring a channel of a person, the method including the operations of, in an IPTV supplementary service control system, receiving from a first set-top box an SOAP message of an IPTV supplementary service request for monitoring the channel of the person; transmitting to an head end a control command containing an IP address of a second set-top box of the to-be-monitored person contained in the SOAP message; in the head end, checking whether or not the second set-top box accepts the monitoring; and in the head end, transmitting to the IPTV supplementary service control system monitoring information including information of a viewer of the second stop box and information of a currently-viewed channel when the monitoring information is received from the second set-top box; and in the IPTV supplementary service control system, transmitting to the first set-top box the monitoring information in a format of the SOAP message.

Accordingly, it is possible to easily generate and provide the IPTV supplementary service by remotely controlling the head end.

### BRIEF DESCRIPTION OF THE DRAWINGS

The above and other features and advantages of the present invention will become more apparent by describing in detail exemplary embodiments thereof with reference to the attached drawings in which:

FIG. 1 is a view illustrating a configuration of a network for providing an IPTV supplementary service according to an embodiment of the present invention;

FIG. 2 is a detailed view illustrating a configuration of an IPTV supplementary service control system according to an embodiment of the present invention;

FIG. 3 is a flowchart of a method of providing an IPTV supplementary service of inviting a person according to an embodiment of the present invention;

FIG. 4 is a flowchart of a method of providing an IPTV supplementary service of monitoring a channel of another person according to an embodiment of the present invention.

### DETAILED DESCRIPTION OF THE INVENTION

Hereinafter, an IPTV supplementary service control system and IPTV supplementary service providing methods according to exemplary embodiments of the present invention will be described in detail with reference to the accompanying drawings.

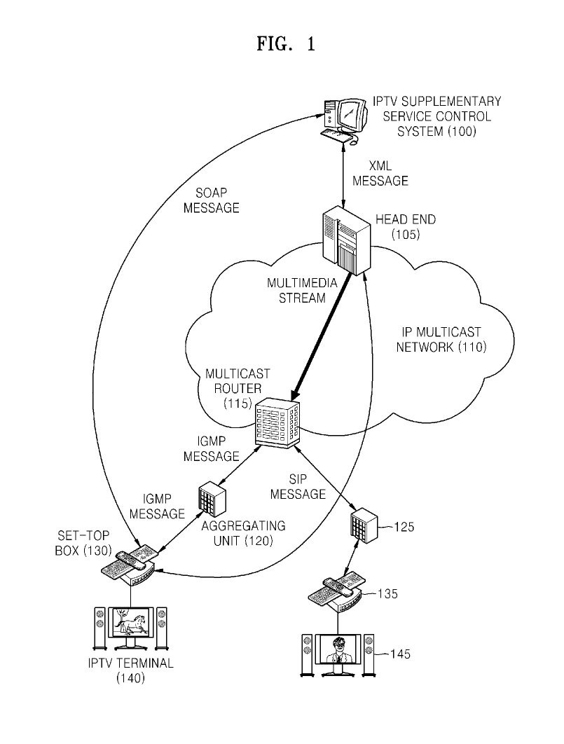

FIG. 1 is a view illustrating a configuration of a network for providing an IPTV supplementary service according to an embodiment of the present invention.

Referring to FIG. 1, the network for providing an IPTV supplementary service includes an IPTV supplementary service control system 100, a head end 105, an multicast router 115 constituting an IP multicast network, aggregating units 120 and 125, set-top boxes 130 and 135, and IPTV terminals 140 and 145.

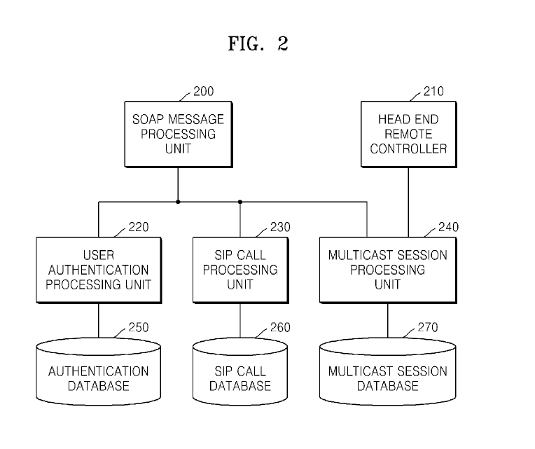

The IPTV supplementary service control system 100 receives a simple object access protocol (SOAP) message from the set-top box 130 and remotely controls the head end 105 to perform a supplementary service. The detailed configuration of the IPTV supplementary service control system 100 is described with reference to FIG. 2. The SOAP is a type of an XML protocol used to call and use objects in a computer.

The head end 105 is a device for transmitting a broadcast content. The head end 105 can store and register the content.

The IP multicast network 110 is an IP network constructed with a plurality of multicast routers. The multicast router 115 transmits the multicast datagram from one multicast group to all networks which the components of the multicast group belong to.

The aggregation unit 120 is a unitary device capable of implementing connection of a larger number of data terminals (i.e. IPTV terminals) that the number of simultaneously-available communication lines among public data transmission lines.

The set-top box 130 is a home communication terminal for a next generation interactive multimedia communication service. The set-top box 130 can receive and analyze digital signals and transmits user's requests to external networks.

The IPTV terminal 140 is connected to the set-top box 130 to provide a service such as video on demand (VOD) to the user.

When the user requests a predetermined IPTV supplementary service (for example, a community service) through the set-top box 130, the set-top box 130 transmits an SOAP message corresponding to the IPTV supplementary service request to the IPTV supplementary service control system 100.

The IPTV supplementary service control system 100 remotely controls the head end 105 according to the IPTV supplementary service request contained in the SOAP message received from the set-top box 130 to enable the IPTV supplementary service to be provided to the user.

For example, in case of a simple view service request, under the control of the IPTV supplementary service control system 100, the head end 105 transmits a multimedia stream of audio data, video data, or the like through an IP multicast network to the multicast router 115 connected to the set-top box 130. The transmitted multimedia stream contains information on all channels.

If an IPTV viewer selects a channel through the IPTV terminal 140, the set-top box 130 connected to the IPTV terminal 140 transmits an Internet group management protocol (IGMP) JOIN message through the aggregating unit 120 to the multicast router 115. The IGMP is a protocol used by the multicast router 115 to identify a member of a host group which exists in a subnet. For example, the multicast router 115 may identify the member of the group by transmitting to each host in each subnet a message of querying whether or not the host intends to join the group or receiving from a host of each subnet a massage that the host intends to join the group. The IGMP JOIN message according to the present invention is a message representing an intention of a set-top box to join the multicast router group.

When the set-top box 130 joins the multicast router 115 and receives the multimedia stream, the IPTV terminal 140 can show the corresponding channel to the user.

When the IPTV supplementary service control system 100 receives from the set-top box 130 a request for the IPTV supplementary service as a convergence of communication and broadcasting using the SOAP message, the head end 105 exchanges a session initiation protocol (SIP) message with the set-top box 130 and provides the IPTV supplementary service to the set-top box 130 under the control of the IPTV supplementary service control system 100.

FIG. 2 is a detailed view illustrating a configuration of an IPTV supplementary service control system according to an embodiment of the present invention.

Referring to FIGS. 1 and 2, the IPTV supplementary service control system 100 includes an SOAP message processing unit 200 which processes an IPTV supplementary service request message that is a kind of the SOAP message, a head end remote controller 210 which remotely controls the head end 105 according to information of the request in the SOAP message, a user authentication processing unit 220 which performs user authentication, an SIP call processing unit 230 which connects an SIP call according to the SOAP message, a multicast session processing unit 240, a authentication database 250, an SIP call database 260, and a multicast session database 270.

When the SOAP message processing unit 200 receives the IPTV supplementary service request message as an SOAP message from the set-top box 130, the SOAP message processing unit 200 requests the user authentication processing unit 220 to perform user authentication in order to check whether the IPTV supplementary service is a authenticated user's request. When it is determined that the request is a authenticated user's request by the user authentication processing unit 220, the SOAP message processing unit 200 distributes the SOAP message to the SIP call processing unit 230 or the multicast session processing unit 240 according to the type of the IPTV supplementary service in the SOAP message. More specifically, in a case where the SOAP massage is associated with a bilateral or multilateral SIP call setting request, the SOAP message processing unit 200 distributes the SOAP message to the SIP call processing units 230. If the SOAP message is associated with a multimedia session request, the SOAP message processing unit 200 distributes the SOAP message to the multimedia session processing units 240. The SOAP message processing unit 200 transmits to the set-top box 130 a response message of informing the set-top box 13 that the SOAP message is normally received and processed.

When receiving the authentication request from the SOAP message processing unit 200, the user authentication processing unit 220 performs user authentication by determining whether or not a user name and a password included in the SOAP message match those stored in the authentication database 250.

If the SOAP message is associated with the call setting request, the SIP call processing unit 230 and the set-top box 130 receive and transmit the SIP message stored in the SIP call database 260.

If the SOAP message is associated with the multimedia session request, the multimedia session processing unit 240 allows the head end remote controller 210 to remotely control the head end 105 in order to process the multimedia session request and stores a multicast address, a channel number, and viewing user information in the multicast session database 270.

In order to process the request in the SOAP message distributed to the multimedia session processing unit 240, the head end remote controller 210 generates and transmits an extensible markup language (XML) message to the head end 105. In addition, the head end remote controller 210 decrypts an XML message received from the head end 105 and generates and transmits a response message for the SOAP message to the user requesting the supplementary service.

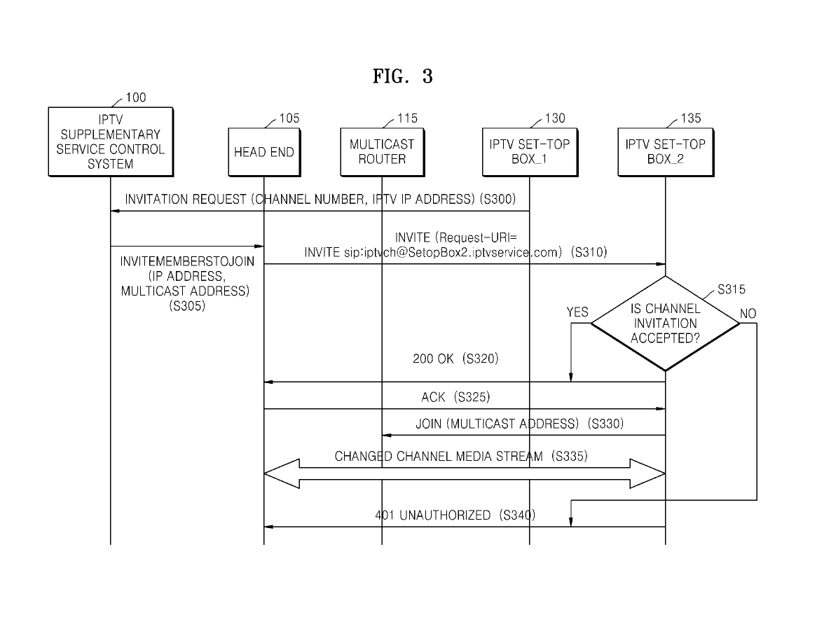

FIG. 3 is a flowchart of a method of providing an IPTV supplementary service for inviting a person according to an embodiment of the present invention.

Referring to FIGS. 1 and 3, while watching IPTV, a person may intend to invite another person. In this case, an SOAP message of inviting the person is transmitted through the set-top box_1 130 to the IPTV supplementary service control system 100 (S300). The SOAP message includes a channel number and an IP address of an invited set-top box.

The IPTV supplementary service control system 100 decrypts the SOAP message received from the set-top box_1 130 to determine whether the SOAP message is associated with the multicast session process. In order to process the request in the SOAP message, the IPTV supplementary service control system 100 transmits an XML message INVITE_MEMBERS_TO_JOIN to the head end 105 (S305). The XML message includes a multicast address corresponding to the IP address and the channel number contained in the SOAP message.

The head end 105 decrypts the XML message and transmits an SIP INVITE message to the IP address of the to-be-invited set-top box_2 135 (S310). The channel information is contained in the user name portion of a Request-URI in the SIP INVITE message. The Request-URI, for example, INVITE sip:IPTVch9@SetopBox2.IPTVservice.com may be transmitted to invite the set-top box_2 135 to Channel 9.

When receiving the INVITE message, the set-top box_2 135 displays on the IPTV terminal connected to the set-top box_2 135 a message “A friend (set-top box_1) is inviting you at Channel 9. Do you accept the invitation?” (S315). If the user answers YES, the set-top box_2 135 transmits an SIP 200 OK message to the head end 105 (S320). When receiving the SIP 200 OK message, the head end 105 transmits an SIP ACK message to the set-top box_2 135 (S325).

When receiving the SIP ACK message (S325), the set-top box_2 135 automatically transmits the IGMP JOIN message to the nearest multicast router 115 (S330). The IGMP JOIN message contains a multicast address of a to-be-newly-viewed channel.

When receiving the IGMP JOIN message, the multicast router 115 transmits a media stream of the to-be-newly-viewed channel contained in the IGMP JOIN message to the set-top box_2 135 (S335).

If the user answers NO to the invitation request displayed on the IPTV terminal of the set-top box_2 135 (S315), the set-top box_2 135 transmits an SIP 401 Unauthorized message to the head end 105 (S340) so that the channel invitation service is terminated.

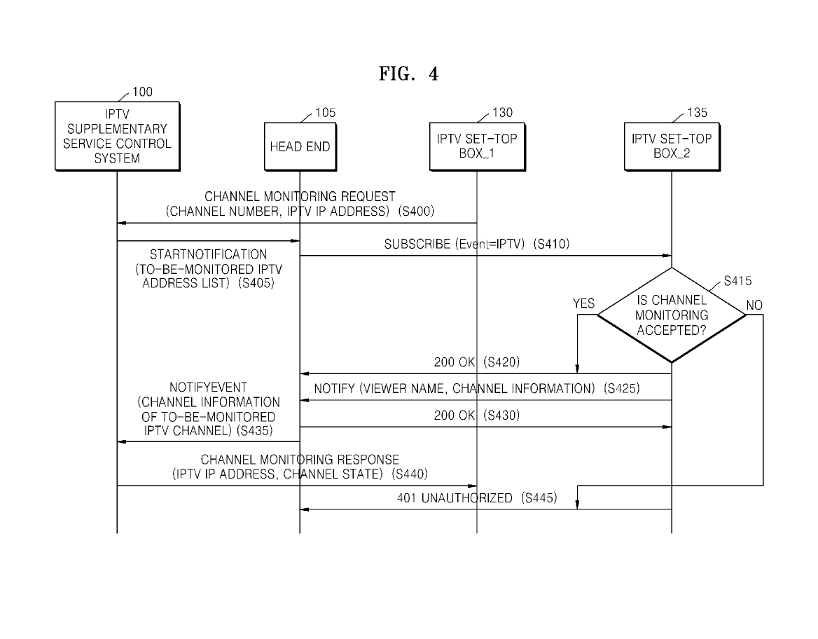

FIG. 4 is a flowchart of a method of providing an IPTV supplementary service for monitoring a channel of another person according to an embodiment of the present invention.

Referring to FIGS. 1 and 4, while watching the IPTV, a user may intend to monitor a channel of another person. In this case, the user transmits an SOAP message of requesting monitoring of the channel through the set-top box_1 130 to the IPTV supplementary service control system 100 (S400). The SOAP message contains a to-be-monitored channel number and an IP address of to-be-monitored set-top box.

The IPTV supplementary service control system 100 decrypts the SOAP message to check that the message is associated with a multicast session process and a channel monitoring request and transmits START_NOTIFICATION XML message to the head end 105 (S405). The START_NOTIFICATION XML message contains an IPTV address list to be monitored.

The head end 105 decrypts the XML message and transmits an SIP SUBSCRIBE message to the IP address of the to-be-monitored set-top box_2 135 (S410). An event header of the SUBSCRIBE message is designated with IPTV.

When receiving the SUBSCRIBE message, the set-top box_2 135 displays on the IPTV terminal a message “A friend (set-top box_1) is monitoring your channel. Do you accept the monitoring?” If the user answer YES (S415), the set-top box_2 135 transmits the SIP 200 OK message to the head end 105 (S420). In addition, the set-top box_2 135 transmits an SIP NOTIFY message containing a viewer name and information of a currently-viewed channel to the head end 105 (S425). When receiving the NOTIFY message, the head end 105 responds with the SIP 200 OK message (S430).

When the head end 105 receives the SIP 200 OK message from the set-top box_2 135 (S420), the head end 105 generates a NOTIFY EVENT XML message containing information on the collected to-be-monitored channels to the IPTV supplementary service control system 100 (S435).

The IPTV supplementary service control system 100 transmits the information of the to-be-monitored channels received from the head end 105 to the set-top box_1 130 (S440). When receiving the channel monitoring response, the set-top box_1 130 displays on the IPTV terminals connected to the set-top box_1 130 the channel information of the to-be-monitored set-top boxes.

If the user of the set-top box_2 135 answers NO to the channel monitoring request (S415), the set-top box_2 135 transmits an SIP 401 Unauthorized message to the head end 105 so that the channel monitoring service is not accepted (S445).

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the present invention, since an IPTV supplementary service control system can be commonly used for all IPTV supplementary services, it is possible to develop fast new supplementary services at low cost without additional separate servers for the supplementary services.

In addition, it is possible to easily develop various supplementary services as a convergence of communication and broadcasting as well as a simple viewing service. In addition, since a simple format of an SOAP massage is transmitted to an IPTV supplementary service control system, it is possible to develop the IPTV supplementary service economically and conveniently.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An IPTV supplementary service control system comprising:
a SOAP message processing unit which decrypts an IPTV supplementary service request contained in a SOAP message received from a set-top box; and
a head end remote controller which generates a control command required to perform the requested IPTV supplementary service and transmits the control command to an head end which transmits a content to the set-top box via a multicast network.

2. The IPTV supplementary service control system of claim 1, wherein the head end remote controller generates the control command in a format of an XML message and transmits the XML message to the head end.

3. The IPTV supplementary service control system of claim 1, further comprising:
an SIP call processing unit which stores call setting information including call identifier information, call sender information, and call receiver information contained in the SOAP message in order to perform an SIP call setting when the SOAP message decrypted by the SOAP message processing unit is associated with a request for the SIP call setting; and
a multicast session processing unit which stores information including a multicast address of a set-top box which is to receive a content corresponding to the IPTV supplementary service and a broadcasting channel number through which the IPTV supplementary service is provided when the SOAP message is associated with a request for a multimedia session process.

4. The IPTV supplementary service control system of claim 1, further comprising a user authentication processing unit which performs user authentication head on a user name and a password contained in the SOAP message

5. A method of providing an IPTV supplementary service by remotely controlling a head end in an IPTV supplementary service control system, the method comprising:
decrypting an IPTV supplementary service request contained in an SOAP message received from a set-top box; and
generating a control command required to perform the request IPTV supplementary service and transmitting the control command to a head end which transmits a content to the set-top box via a multicast network.

6. The method of claim 5, wherein in the generating of the control command, the control command is generated in a format of an XML message and the XML message is transmitted to the head end.

7. The method of claim 5,
wherein the decrypting of the SOAP message comprises determining whether the IPTV supplementary service is associated with a request for a multimedia session process or a request for an SIP call setting,
wherein the transmitting of the control command comprises:
storing call setting information including call identifier information, call sender information, and call receiver information contained in the SOAP message in order to perform the SIP call setting when the SOAP message is associated with the request for the SIP call setting; and
storing information including a multicast address of a set-top box which is to receive a content corresponding to the IPTV supplementary service and a broadcasting channel number through which the IPTV supplementary service is provided when the SOAP message is associated with the request for the multimedia session process; and
generating a control command in a format of an XML message according to a type of the IPTV supplementary service request and transmitting the XML message to the head end.

8. A method of providing an IPTV supplementary service for inviting a person to a channel, the method comprising:
in an IPTV supplementary service control system, receiving from a first set-top box an SOAP message of an IPTV supplementary service request for inviting the person to the channel;
transmitting to an head end a control command containing an IP address of a second set-top box of the invited person and the channel number contained in the SOAP message;
in the head end, checking whether or not the second set-top box accepts the invitation; and
in the head end, transmitting a content corresponding to the channel to the second set-top box through the channel when the invitation accepting message is received from the second set-top box.

9. The method of claim 8, wherein the checking comprises:
in the head end, transmitting to the second set-top box an SIP INVITE message containing the channel number; and
receiving an SIP 200 OK message indicating that the second set-top box accepts the invitation or an SIP 401 unauthorized message indicating that the second set-top box does not accept the invitation.

10. A method of providing an IPTV supplementary service for monitoring a channel of a person, the method comprising:
in an IPTV supplementary service control system, receiving from a first set-top box an SOAP message of an IPTV supplementary service request for monitoring the channel of the person;
transmitting to an head end a control command containing an IP address of a second set-top box of the to-be-monitored person contained in the SOAP message;
in the head end, checking whether or not the second set-top box accepts the monitoring; and
in the head end, transmitting to the IPTV supplementary service control system monitoring information including information of a viewer of the second stop box and information of a currently-viewed channel when the monitoring information is received from the second set-top box; and
in the IPTV supplementary service control system, transmitting to the first set-top box the monitoring information in a format of the SOAP message.

11. The method of claim 10, wherein the checking comprises:
in the head end, transmitting to the second set-top box an SIP SUBSCRIBE message; and
receiving an SIP 200 OK message indicating that the second set-top box accepts the monitoring or an SIP 401 unauthorized message indicating that the second set-top box does not accept the monitoring.
